(19) United States
(12) Patent Application Publication
(10) Pub. No.: US 2026/0170515 A1
(43) Pub. Date: Jun. 18, 2026

(54) Data Processing Device, Data Processing Method, and Data Processing Program

(71) Applicant: Softbank Group Corp., Tokyo (JP)

(72) Inventor: Yuya Okawa, Tokyo (JP)

(21) Appl. No.: 19/414,479

(22) Filed: Dec. 10, 2025

(30) Foreign Application Priority Data
Dec. 12, 2024 (JP) 2024-217579

(51) Int. Cl. G06Q 30/0201; G06Q 10/02; G06Q 10/083

(52) U.S. Cl. CPC G06Q 30/0201; G06Q 10/02; G06Q 10/083

(57) ABSTRACT

A data processing device includes a processor configured to acquire, as user data, image data indicating an image of an area including a sales area for products in a sales store for the product; perform, as specific processing, processing of generating sales status information based on the user data, the sales status information indicating a sales status for the products in the sales store, by inputting, into a data generation model that generates a predetermined inference result according to the user data, a prompt for instructing the generation of the sales status information; and output the sales status indicated by the sales status information as a result of the specific processing to a device of a producer who produces the products.

### CROSS REFERENCE TO RELATED APPLICATIONS

The present application claims priority from Japanese Patent Application No. 2024-217579, filed on Dec. 12, 2024, the entire disclosure of which is incorporated herein by reference.

### BACKGROUND

### Technical Field

The technology of the present disclosure relates to a data processing device, a data processing method, and a data processing program.

### Related Art

Japanese Patent Application Laid-Open (JP-A) No. 2022-180282 discloses a persona chatbot control method executed by at least one processor, the method including: receiving a user utterance; adding the user utterance to a prompt including an instruction statement associated with a description of a chatbot character; encoding the prompt; and inputting the encoded prompt into a language model to generate a chatbot utterance responding to the user utterance.

### SUMMARY OF THE INVENTION

However, in the prior art, there is room for improvement in terms of efficiency of distribution when the prior art is applied to the distribution of products.

A first aspect according to the technology of the present disclosure is a data processing device including: an input unit configured to acquire user data; a processing unit configured to perform specific processing using a data generation model that generates a predetermined inference result according to the user data; and an output unit configured to output a result of the specific processing to a predetermined device, in which the input unit acquires, as the user data, image data indicating an image of an area including a sales area for products in a sales store for the product, the processing unit performs, as the specific processing, processing of generating sales status information based on the user data, the sales status information indicating a sales status for the products in the sales store, by inputting, into the data generation model, a prompt for instructing the generation of the sales status information, and the output unit outputs the sales status indicated by the sales status information to a device of a producer who produces the products.

A second aspect according to the technology of the present disclosure is a data processing method executed by a computer, the data processing method including: acquiring user data; performing specific processing using a data generation model that generates a predetermined inference result according to the user data; and outputting a result of the specific processing to a predetermined device, in which image data is acquired as the user data, the image data indicating an image of an area including a sales area for products in a sales store for the product, processing of generating sales status information based on the user data is performed as the specific processing, the sales status information indicating a sales status for the products in the sales store, by inputting, into the data generation model, a prompt for instructing the generation of the sales status information, and the sales status indicated by the sales status information is output to a device of a producer who produces the products.

A third aspect according to the technology of the present disclosure is a data processing program for causing a computer to execute: acquiring user data; performing specific processing using a data generation model that generates a predetermined inference result according to the user data; and outputting a result of the specific processing to a predetermined device, in which image data is acquired as the user data, the image data indicating an image of an area including a sales area for products in a sales store for the product, processing of generating sales status information based on the user data is performed as the specific processing, the sales status information indicating a sales status for the products in the sales store, by inputting, into the data generation model, a prompt for instructing the generation of the sales status information, and the sales status indicated by the sales status information is output to a device of a producer who produces the products.

### BRIEF DESCRIPTION OF THE DRAWINGS

FIG. 1 is a conceptual diagram illustrating an example of a configuration of a data processing system according to an embodiment;

FIG. 2 is a conceptual diagram illustrating an example of functions of main parts of a data processing device and a smart device according to an embodiment;

FIG. 3 is a schematic diagram illustrating an outline of specific processing according to an embodiment;

FIG. 4 is a block diagram schematically illustrating a functional configuration of a specific processing unit of the data processing device according to an embodiment;

FIG. 5 is a flowchart schematically illustrating an example of a flow of a first specific processing operation performed by the data processing device according to an embodiment;

FIG. 6 is a diagram illustrating an example of a sales status screen (part 1) according to an embodiment;

FIG. 7 is a diagram illustrating an example of a sales status screen (part 2) according to an embodiment;

FIG. 8 is a diagram illustrating an example of a sales status screen (part 3) according to an embodiment;

FIG. 9 is a diagram illustrating an example of a reservation completion screen according to an embodiment;

FIG. 10 is a flowchart schematically illustrating an example of a flow of a second specific processing operation performed by the data processing device according to an embodiment; and

FIG. 11 is a flowchart schematically illustrating an example of a flow of a third specific processing operation performed by the data processing device according to an embodiment.

### DETAILED DESCRIPTION OF THE INVENTION

Hereinafter, embodiments of a data processing device, a data processing method, and a data processing program according to the technology of the present disclosure will be described with reference to the accompanying drawings.

First, words used in the following description will be described.

In the following embodiments, a processor to which a reference sign is attached (hereinafter, simply referred to as “processor”) may be one arithmetic device or a combination of a plurality of arithmetic devices. In addition, the processor may be one type of arithmetic device or a combination of a plurality of types of arithmetic devices. Examples of the arithmetic device include a central processing unit (CPU), a graphics processing unit (GPU), a general-purpose computing on graphics processing unit (GPGPU), an accelerated processing unit (APU), and the like.

In the following embodiments, a random access memory (RAM) to which a reference sign is attached is a memory in which information is temporarily stored, and is used as a work memory by the processor.

In the following embodiments, a storage to which a reference sign is attached is one or more nonvolatile storage devices that store various programs, various parameters, and the like. Examples of the nonvolatile storage device include a flash memory (solid state drive (SSD)), a magnetic disk (e.g., a hard disk), and a magnetic tape.

In the following embodiments, a communication interface (I/F) to which a reference sign is attached is an interface including a communication processor, an antenna, etc. The communication I/F manages communication between a plurality of computers. Examples of the communication standard applied to the communication I/F include wireless communication standards including a 5th generation mobile communication system (5G), Wi-Fi (registered trademark), and Bluetooth (registered trademark).

In the following embodiments, “A and/or B” is synonymous with “at least one of A or B.” That is, “A and/or B” means only A, only B, or a combination of A and B. Furthermore, in the present specification, the same concept as “A and/or B” is applied also in a case where three or more things are expressed in a combined manner by “and/or”.

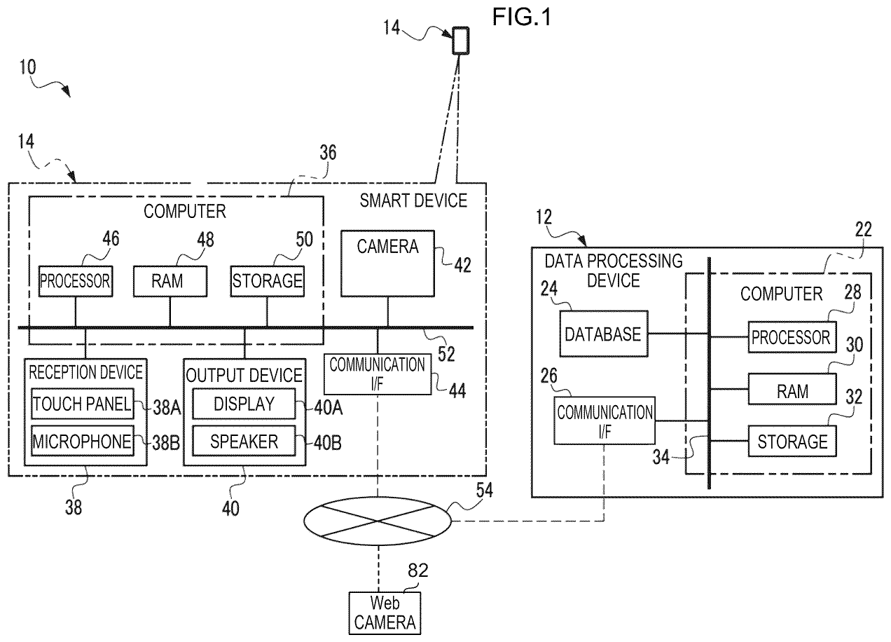

FIG. 1 illustrates an example of a configuration of a data processing system 10 according to an embodiment. Hereinafter, a case will be described in which agricultural products are applied as products of the present disclosure, and a direct sales store for the agricultural products is applied as a sales store of the present disclosure.

As illustrated in FIG. 1, the data processing system 10 includes a data processing device 12 and a smart device 14. Examples of the data processing device 12 include a server. Examples of the smart device 14 include a smartphone. In the present embodiment, the data processing device 12 is an example of a “data processing device” according to the technology of the present disclosure. The smart device 14 according to the present embodiment is possessed by a user (a producer of agricultural products in the present embodiment).

The data processing device 12 includes a computer 22, a database 24, and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a wide area network (WAN) and/or a local area network (LAN).

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. The reception device 38, the output device 40, and the camera 42 are also connected to the bus 52.

The reception device 38 includes a touch panel 38A, a microphone 38B, and the like, and receives a user input. The touch panel 38A detects a contact of a pointer (e.g., a pen, a finger, or the like) and receives a user input based on the contact of the pointer. The microphone 38B detects a user's voice and receives a user input based on the voice. A control unit 46A, which will be described later, transmits data indicating the user input received through the touch panel 38A and the microphone 38B to the data processing device 12. In the data processing device 12, a specific processing unit 290, which will be described later, acquires the data indicating the user input.

The output device 40 includes a display 40A, a speaker 40B, and the like, and presents data to the user by outputting the data in a user-perceptible expression (e.g., voice and/or text). The display 40A displays visible information such as text and images in accordance with an instruction from the processor 46. The speaker 40B outputs a voice in accordance with an instruction from the processor 46. The camera 42 is a small digital camera on which an optical system including a lens, a diaphragm, a shutter, etc. and an imaging element such as a complementary metal-oxide-semiconductor (CMOS) image sensor or a charge coupled device (CCD) image sensor are mounted.

The communication I/F 44 is connected to the network 54. The communication I/Fs 44 and 26 manage exchange of various types of information between the processor 46 and the processor 28 via the network 54.

In the data processing system 10 according to the present embodiment, a web camera 82 that captures an image of an area including a sales area for the agricultural products in the direct sales store for the agricultural products is connected to the network 54. In order to avoid complication, only one web camera 82 is illustrated in FIG. 1, but actually, web cameras 82 are provided in sales areas for agricultural products of direct sales stores installed at a plurality of points targeted by the data processing system 10, respectively, and all the web cameras 82 are connected to the network 54. Therefore, the data processing device 12 can acquire image data obtained by capturing images using the web cameras 82 from all the web cameras 82 via the network 54.

In the present embodiment, image data indicating an image including a sales area for agricultural products of a direct sales store is acquired using the web camera 82 as described above, but the acquisition of the image data is not limited to this mode. For example, a terminal device capable of image capturing and capable of connection to the Internet, such as a smartphone or a tablet terminal, may be applied instead of the web camera 82.

Note that, although not illustrated, the network 54 is connected with a vehicle management server that manages an automated vehicle that delivers agricultural products from a producer's home, an agricultural product production site, or the like to a direct sales store, which will be described later, and the data processing device 12 can exchange various types of information with the vehicle management server. The automated vehicle mentioned herein refers to a vehicle that can automatically move in a set section without requiring a driver.

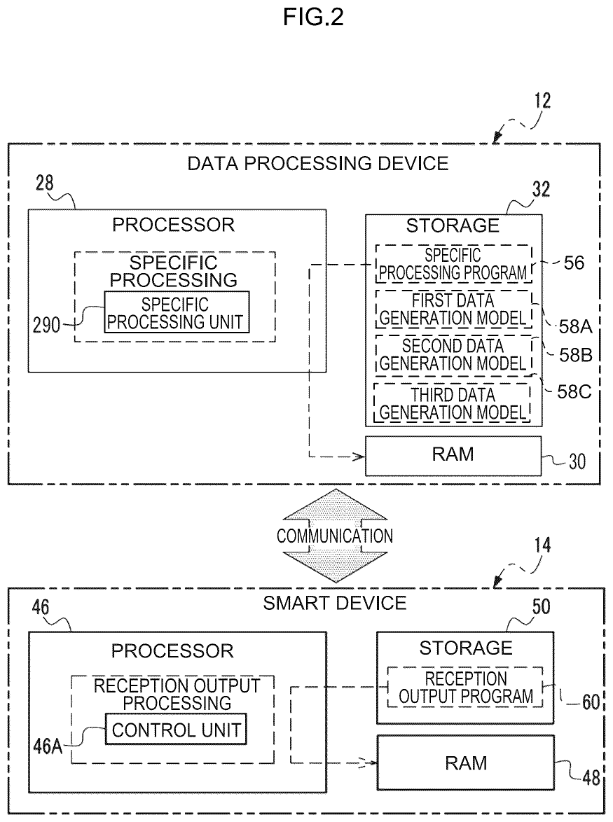

FIG. 2 illustrates an example of functions of main parts of the data processing device 12 and the smart device 14.

As illustrated in FIG. 2, in the data processing device 12, specific processing is performed by the processor 28. The storage 32 stores a specific processing program 56. The specific processing program 56 is an example of a “data processing program” according to the technology of the present disclosure. The processor 28 reads the specific processing program 56 from the storage 32 and executes the read specific processing program 56 on the RAM 30. The specific processing is realized by the processor 28 operating as the specific processing unit 290 according to the specific processing program 56 executed on the RAM 30.

The storage 32 stores three data generation models: a first data generation model 58A, a second data generation model 58B, and a third data generation model 58C. The first data generation model 58A, the second data generation model 58B, and the third data generation model 58C are used by the specific processing unit 290. Hereinafter, the first data generation model 58A, the second data generation model 58B, and the third data generation model 58C will be collectively referred to as “data generation model 58” when described without distinction.

In the smart device 14, reception output processing is performed by the processor 46. The storage 50 stores a reception output program 60. The reception output program 60 is used in combination with the specific processing program 56 by the data processing system 10. The processor 46 reads the reception output program 60 from the storage 50 and executes the read reception output program 60 on the RAM 48. The reception output processing is realized by the processor 46 operating as the control unit 46A according to the reception output program 60 executed on the RAM 48.

Next, processing of the specific processing unit 290 when the data processing device 12 performs the specific processing to improve the efficiency of distribution of agricultural products will be described.

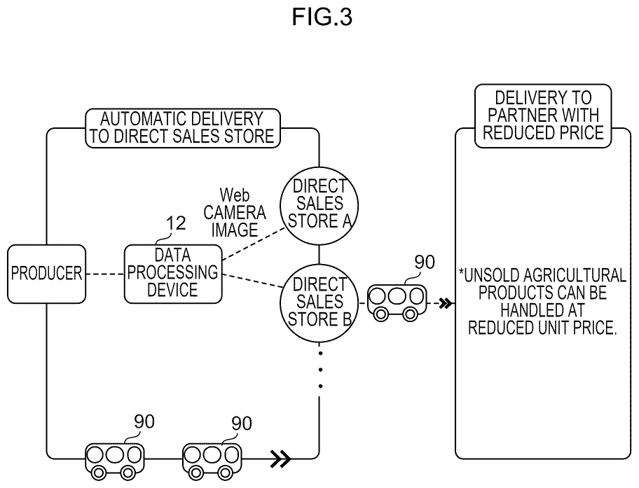

FIG. 3 is a schematic diagram illustrating an outline of the specific processing according to the present embodiment. As illustrated in FIG. 3, the specific processing in the present embodiment includes first specific processing of presenting information indicating a sales status for agricultural products in a direct sales store to a producer using image data acquired from the web camera 82, and receiving a reservation for automatic delivery of the agricultural products through an automated vehicle 90 from the producer to the direct sales store. In addition, the specific processing in the present embodiment includes second specific processing of arranging an automated vehicle 90 to deliver the agricultural products from the producer to the direct sales store. Furthermore, the specific processing in the present embodiment includes third specific processing of arranging delivery of agricultural products unsold at the direct sales store to a predetermined partner seller (hereinafter, referred to as “secondary distribution destination” or “secondary distributor”) through an automated vehicle 90.

The data processing device 12 according to the present embodiment uses the first data generation model 58A when performing the first specific processing. In addition, the data processing device 12 according to the present embodiment uses the second data generation model 58B when performing the second specific processing. Furthermore, the data processing device 12 according to the present embodiment uses the third data generation model 58C when performing the third specific processing.

In the present embodiment, the first specific processing, the second specific processing, and the third specific processing are performed using the individually prepared data generation models 58 as described above, but the performing of the first specific processing, the second specific processing, and the third specific processing is not limited to this mode. For example, the first specific processing, the second specific processing, and the third specific processing may be performed using a single data generation model 58, or a combination of two of the first specific processing, the second specific processing, and the third specific processing may be performed using a common data generation model 58, and the remaining specific processing may be performed using another data generation model 58.

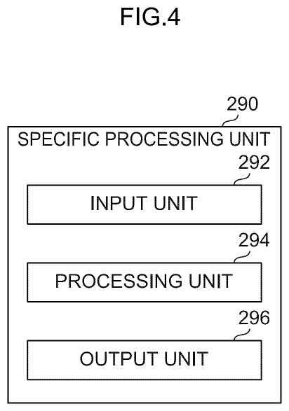

As illustrated in FIG. 4, the specific processing unit 290 includes an input unit 292, a processing unit 294, and an output unit 296.

The input unit 292 acquires user data. Specifically, the input unit 292 acquires, as the user data, image data indicating an image of an area including a sales area for products (agricultural products in the present embodiment) in a sales store (a direct sales store in the present embodiment) for the products. More specifically, the input unit 292 acquires image data indicating latest past moving images captured by the plurality of web cameras 82 provided in the plurality of direct sales stores, respectively, in a predetermined period (one week in the present embodiment).

The processing unit 294 performs specific processing using the data generation model 58 that generates a predetermined inference result according to the user data. Specifically, by inputting, into the first data generation model 58A, a prompt for instructing generation of sales status information indicating a sales status for products in a sales store based on the user data, the processing unit 294 performs processing of generating the sales status information as the first specific processing. More specifically, by inputting, into the first data generation model 58A, a prompt for instructing generation of sales status information for direct sales stores at a plurality of points, the processing unit 294 performs processing of generating the sales status information for the direct sales stores at the plurality of points as the first specific processing.

The output unit 296 outputs a result of the first specific processing to a predetermined device. Specifically, the output unit 296 outputs the sales status indicated by the sales status information to the smart device 14 of the producer who produces the products. More specifically, the output unit 296 outputs a sales status screen displaying the sales status indicated by the sales status information for each of the direct sales stores at the plurality of points so as to be displayable on the smart device 14 of the producer of the agricultural products.

In the present embodiment, agricultural products are applied as the products, and a direct sales store for the agricultural products is applied as the sales store as described above, but the products and the sales store are not limited to this mode. For example, industrial parts may be applied as the products, and a store that sells the industrial parts may be applied as the sales store, or medicines may be applied as the products, and a pharmacy that sells the medicines may be applied as the sales store.

In the present embodiment, the sales status information includes information regarding excessively supplied agricultural products (hereinafter, referred to as “excessive supply information”), information regarding insufficient agricultural products (hereinafter, referred to as “shortage information”), information regarding agricultural products that are sold well (Hereinafter, it is referred to as “best-selling information”), information regarding the number of visitors to a direct sales store (hereinafter, referred to as “visitor number information”), and information indicating an estimated future shipment amount for each type of agricultural product in a direct sales store (hereinafter referred to as “estimated shipment amount information”).

In the present embodiment, the sales status information includes all of the excessive supply information, the shortage information, the best-selling information, the visitor number information, and the estimated shipment amount information, but the sales status information is not limited to this mode. For example, one of these types of information may be included in the sales status information, or a combination of a plurality of types of information excluding a combination of all types of information among these types of information may be included in the sales status information.

In addition, the input unit 292 further acquires, as the user data, reservation data indicating that a reservation for delivering the agricultural products produced by the producer to the direct sales store is made from the producer. Specifically, the input unit 292 acquires latest past reservation data made by a plurality of producers in a predetermined period (one day in the present embodiment). Note that, in the present embodiment, data indicating a desired direct sales store, delivery date, and pickup time zone designated by the producer is applied as the reservation data, but the reservation data is not limited to this mode. For example, in addition to these data, data indicating a desired type and quantity of agricultural products to be delivered may be applied as the reservation data.

Then, the processing unit 294 further performs, as the specific processing, processing of arranging a delivery vehicle to deliver agricultural products from the producer to the direct sales store according to the reservation indicated by the reservation data. Specifically, for each of the producers, by inputting, into the second data generation model 58B, a prompt for instructing generation of delivery vehicle information indicating a delivery vehicle and movement route information indicating a movement route capable of efficiently delivering the agricultural products to the desired direct sales store from each producer based on the acquired reservation data, the processing unit 294 performs processing of generating delivery vehicle information and movement route information. Then, the processing unit 294 performs processing of arranging a delivery vehicle using the generated delivery vehicle information and movement route information as the second specific processing.

Here, the delivery vehicle is the above-described automated vehicle 90 that automatically moves in a set section, and the processing unit 294 also performs, as the second specific processing, processing of setting a section between the producer and the corresponding direct sales store as the section.

In the present embodiment, the automated vehicle 90 is applied as the delivery vehicle, and the processing unit 294 performs processing of setting a section between the producer and the corresponding direct sales store as the section as described above, but the delivery vehicle and the section are not limited to this mode. For example, a normal vehicle driven by a driver may be applied as the delivery vehicle.

Further, the processing unit 294 further performs processing of arranging delivery of agricultural products unsold after the end of sale for the agricultural products in the direct sales store to a predetermined seller using the image data described above as the specific processing.

Specifically, the input unit 292 acquires, from the web camera 82 in each direct sales store, image data indicating the latest past moving image captured in a predetermined period (10 minutes in the present embodiment). In addition, by inputting, into the third data generation model 58C, a prompt for instructing generation of selection result information indicating a result of selecting a secondary distributor that will be an appropriate secondary distribution destination for the unsold agricultural products based on the acquired image data, the processing unit 294 performs processing of generating the selection result information as the third specific processing. Then, using the generated selection result information, the processing unit 294 performs processing of arranging an automated vehicle 90 for delivering the unsold agricultural products to the secondary distributor as the third specific processing.

The first data generation model 58A, the second data generation model 58B, and the third data generation model 58C are so-called generative artificial intelligence (AI). Examples of these data generation models 58 include generative AI such as ChatGPT (registered trademark) (Internet search <URL:https://openai.com/blog/chatgpt>) and Gemini (registered trademark) (Internet search <URL:https://gemini.google.com/?hl=ja>). The data generation model 58 is obtained by causing a neural network to perform deep learning. To the data generation model 58, a prompt including an instruction is input, and inference data such as voice data indicating a voice, text data indicating a text, or image data indicating an image is input. The data generation model 58 infers the input inference data according to the instruction indicated by the prompt, and outputs an inference result in a data format such as voice data, image data, or text data. Here, the inference refers to, for example, analysis, classification, prediction, and/or summary.

For example, together with the image data acquired from the plurality of direct sales stores by the input unit 292, the processing unit 294 inputs, into the first data generation model 58A, the following prompt (hereinafter referred to as “first prompt”): “This is image data indicating the latest moving image of the sales area for agricultural products in each direct sales store over the past one week. From this moving image, please generate information regarding excessively supplied agricultural products, information regarding insufficient agricultural products, information regarding agricultural products that are sold well, information regarding the number of visitors to each direct sales store, and information indicating an estimated future shipment amount for each type of agricultural product in each direct sales store during this period.” As a result, the excessive supply information, the shortage information, the best-selling information, the visitor number information, and the estimated shipment amount information, which are described above, are generated as the sales status information by the first data generation model 58A.

In addition, for example, together with the reservation data acquired by the input unit 292, the processing unit 294 input, into the second data generation model 58B, the following prompt (hereinafter referred to as “second prompt”): “This is reservation data indicating the latest delivery vehicle reservation status during the past one day for each producer. From this reservation status, for each producer, please generate delivery vehicle information indicating an automated vehicle and movement route information indicating a movement route capable of efficiently delivering agricultural products to a direct sales store desired by each producer.” As a result, the delivery vehicle information and the movement route information are generated by the second data generation model 58B.

Furthermore, for example, together with the image data acquired by the input unit 292, the processing unit 294 inputs, into the third data generation model 58C, the following prompt (hereinafter referred to as “third prompt”): “This is image data indicating a current status of agricultural products in each direct sales store. Please derive the type and amount of unsold agricultural products from the status of agricultural products, select an appropriate secondary distributor from among partners in consideration of this result, and generate selection result information indicating a selection result.” As a result, the selection result information is generated by the third data generation model 58C.

Next, the operation of the data processing system 10 will be described.

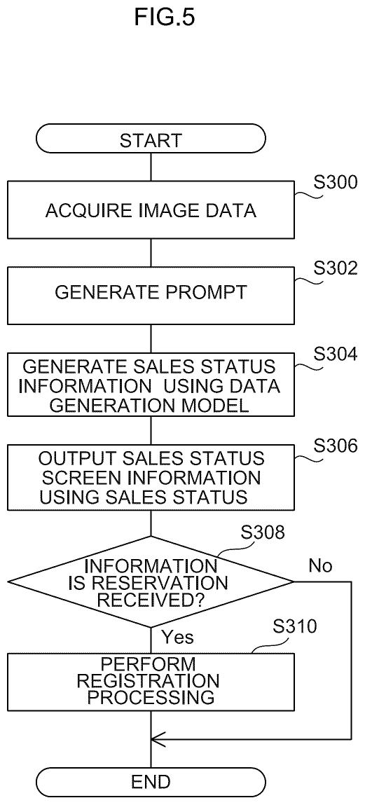

First, a flow of the first specific processing in the specific processing will be described with reference to FIG. 5. Note that the flow of the first specific processing illustrated in FIG. 5 is an example of a “data processing method” according to the technology of the present disclosure. The first specific processing according to the present embodiment is executed when an instruction input for an instruction to display a sales status screen is made by any producer via the smart device 14. In order to avoid complication, here, a case will be described in which latest image data for the past one week captured by the web camera 82 provided in each direct sales store (hereinafter, simply referred to as “image data”) is sequentially accumulated (updated) in the database 24.

In step S300, the input unit 292 reads and acquires all image data from the database 24.

In step S302, the processing unit 294 generates the first prompt described above as an example.

In step S304, the processing unit 294 generates the above-described sales status information by inputting the generated first prompt together with the read image data into the first data generation model 58A. Here, as described above, the generated sales status information includes excessive supply information, shortage information, best-selling information, visitor number information, and estimated shipment amount information.

In step S306, using the generated sales status information, the output unit 296 outputs a sales status screen displaying the sales status indicated by the sales status information for each of the direct sales stores at the plurality of points so as to be displayable on the smart device 14 of the producer from which access has been made.

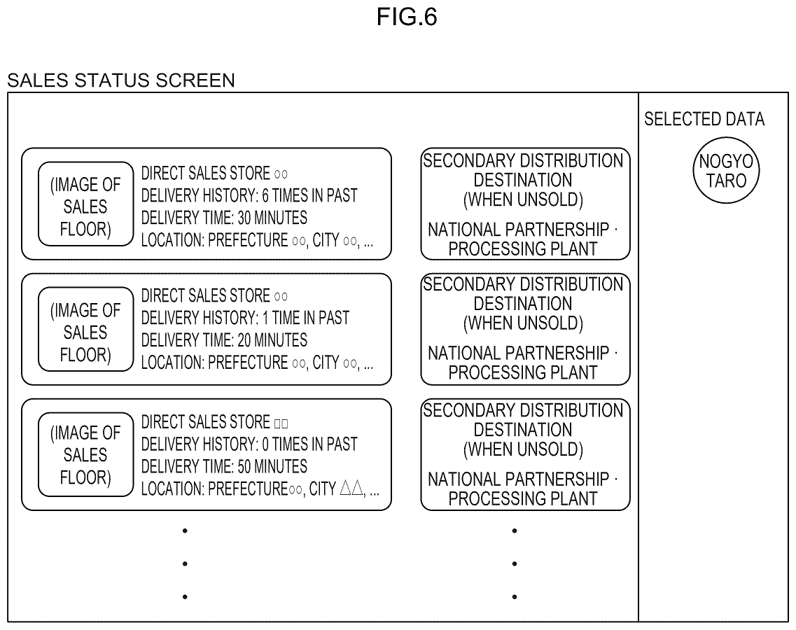

FIG. 6 illustrates an example of a sales status screen displayed by the display 40A of the smart device 14 from which access has been made.

As illustrated in FIG. 6, this sales status screen displays information indicating a producer possessing the smart device 14 (hereinafter, simply referred to as “producer”) from which access has been made (information “Nogyo Taro” in the example illustrated in FIG. 6).

In addition, this sales status screen displays, for each of the direct sales stores, an image of the sales area captured by the web camera 82 (here, the latest still image), information indicating a history of delivery of agricultural products to the direct sales store corresponding to the producer (hereinafter, simply referred to as “direct sales store”), information indicating an estimated time for delivery from the producer to the direct sales store, and information indicating the address of the direct sales store.

In addition, this sales status screen displays information indicating a secondary distribution destination for each of the direct sales stores in a case where unsold agricultural products occur in the direct sales store. Therefore, various types of information displayed on the sales status screen illustrated in FIG. 6 are registered in the database 24 of the data processing device 12 according to the present embodiment.

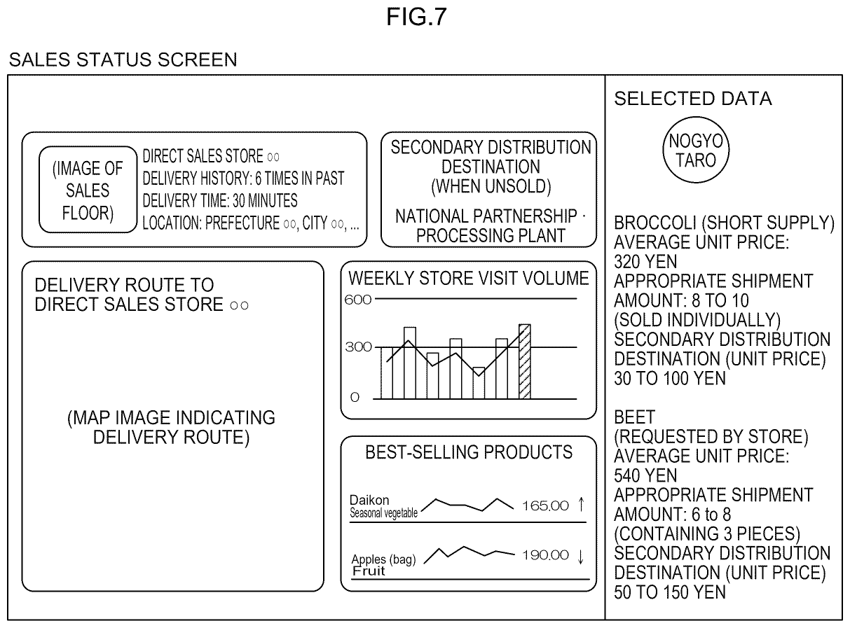

When the sales status screen illustrated in FIG. 6 is displayed on the display 40A of the smart device 14, the producer designates, via the touch panel 38A, a display area for a direct sales store to which the producer desires to deliver agricultural products he or she has produced. When the display area for any direct sales store is designated by the producer, the sales status screen changes to one illustrated in FIG. 7 as an example.

As illustrated in FIG. 7, while maintaining the display of the information regarding the direct sales store designated by the producer, this sales status screen displays a map image indicating a delivery route from the producer to the direct sales store. Therefore, information (the address in the present embodiment) indicating a location from which the agricultural products of each corresponding producer are loaded out is also registered in advance in the database 24 of the data processing device 12 according to the present embodiment. Note that the map image indicating the delivery route can be created using conventionally known route search software.

In addition, this sales status screen displays information indicating a change in the number of visitors to the direct sales store (displayed as “weekly store visit volume” in the example illustrated in FIG. 7), which is created using the visitor number information, and information indicating a change in the price of best-selling agricultural products (displayed as “best-selling products” in the example illustrated in FIG. 7), which is created using the best-selling information.

In addition, this sales status screen displays information indicating an average unit price, an appropriate shipment amount, and a unit price at a secondary distribution destination for agricultural products that are in short supply (“broccoli (short supply)” in the example illustrated in FIG. 7), which is created using the shortage information.

Furthermore, this sales status screen displays information regarding agricultural products that are requested to be delivered by the direct sales store (the display regarding “beet (requested by store)” in the example illustrated in FIG. 7). Therefore, in the data processing system 10 according to the present embodiment, the information regarding agricultural products requested to be delivered by the direct sales store is registered in the database 24 of the data processing device 12 by a person in charge of the direct sales store.

Although not illustrated, the sales status screen illustrated in FIG. 7 can display, as a modal screen or a pop-up screen of the sales status screen, information indicating agricultural products that are in excess in a corresponding direct sales store, which is indicated by the excessive supply information, and information indicating an estimated future shipment amount for each type of agricultural product, which is indicated by the estimated shipment amount information.

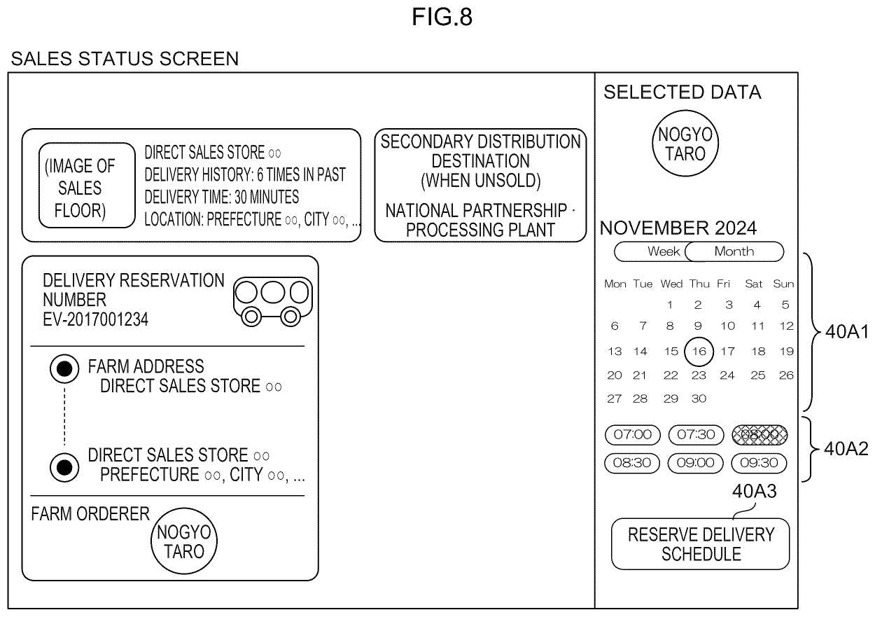

When the sales status screen illustrated in FIG. 7 is displayed on the display 40A of the smart device 14, in a case where the producer makes a reservation for delivering agricultural products to the displayed direct sales store using a delivery vehicle, the producer designates a map image indicating the above-described delivery route via the touch panel 38A. When the map image is designated by the producer, the sales status screen changes to one illustrated in FIG. 8 as an example.

As illustrated in FIG. 8, while maintaining the display of the information regarding the direct sales store designated by the producer, the sales status screen displays a calendar 40A1 including a schedule on and after the current day and a time zone reception button 40A2 for receiving designation of one of the available pickup time zones (time zones in 30-minute increments from 7:00 to 9:30 in the example illustrated in FIG. 8).

When the calendar 40A1 and the time zone reception button 40A2 are displayed, the producer designates a date on which agricultural products are desired to be delivered by a delivery vehicle on the calendar 40A1 via the touch panel 38A. In addition, the producer designates a time zone reception button 40A2 corresponding to a time zone in which the agricultural products are desired to be picked up via the touch panel 38A, and then designates a reservation button 40A3 via the touch panel 38A.

Therefore, in step S308, the processing unit 294 determines whether or not the reservation button 40A3 is designated by the producer, and ends the first specific processing when the determination is negative, and proceeds to step S310 when the determination is positive.

In step S310, the processing unit 294 performs predetermined registration processing, and then ends the first specific processing.

Note that, in the present embodiment, as the registration processing, the above-described reservation data indicating the direct sales store, the delivery date, and the pickup time zone, which is designated by the producer, is registered in the database 24, and a provisional reservation is made for an automated vehicle 90 that has not been reserved for the reserved schedule, and information regarding the reservation (information indicating the “delivery reservation number” and the like in the example illustrated in FIG. 8) is displayed on the sales status screen, but it is needless to say that the registration processing is not limited to this mode.

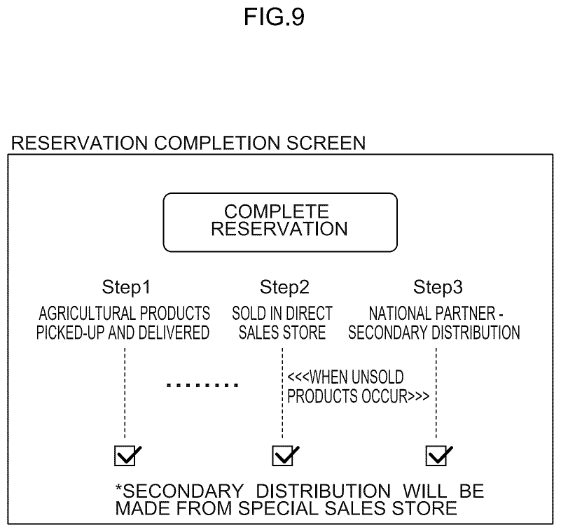

Note that FIG. 9 illustrates an example of a reservation completion screen displayed on the display 40A of the smart device 14 after the above-described first specific processing is completed.

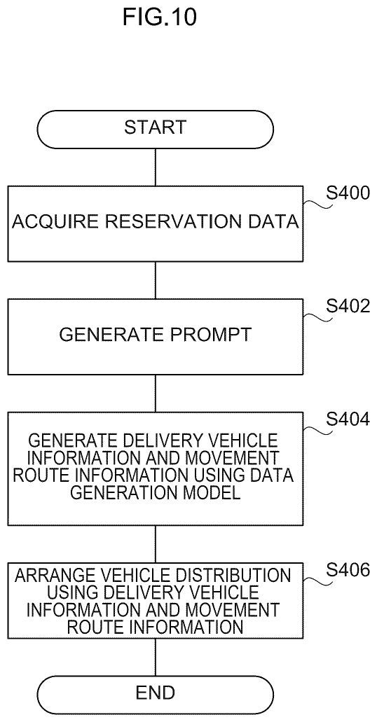

Next, a flow of the second specific processing in the specific processing will be described with reference to FIG. 10. The second specific processing according to the present embodiment is executed at a predetermined timing (at midnight every day in the present embodiment).

In step S400, the input unit 292 reads and acquires all the reservation data registered in the latest one day from the database 24.

In step S402, the processing unit 294 generates the second prompt described above as an example.

In step S404, the processing unit 294 generates the above-described delivery vehicle information and movement route information by inputting the generated second prompt together with the read reservation data into the second data generation model 58B.

In step S406, using the generated delivery vehicle information and movement route information, the processing unit 294 executes processing of arranging an automated vehicle 90 according to these types of information with respect to the vehicle management server described above, including setting of the above-described section for the automated vehicle 90, and then ends the second specific processing.

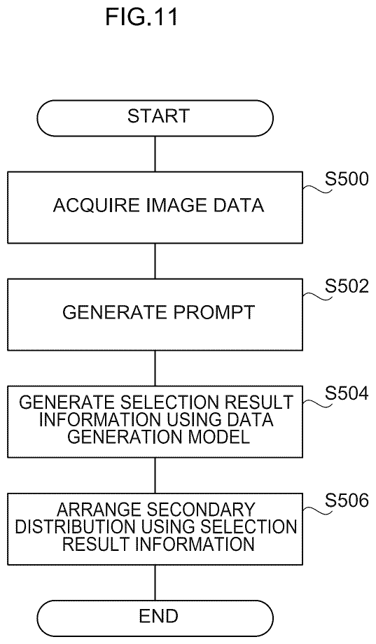

Next, a flow of the third specific processing in the specific processing will be described with reference to FIG. 11. The third specific processing according to the present embodiment is executed at a predetermined timing (at the end of the operating hours of each direct sales store on a daily basis in the present embodiment).

In step S500, the input unit 292 reads and acquires the latest image data registered at that time from the database 24.

In step S502, the processing unit 294 generates the third prompt described above as an example.

In step S504, the processing unit 294 generates the above-described selection result information by inputting the generated third prompt together with the read image data to the third data generation model 58C.

In step S506, using the generated selection result information, the processing unit 294 executes, with respect to the above-described vehicle management server, processing of arranging delivery of unsold agricultural products from the direct sales store that sells the unsold agricultural products to the selected secondary distributor, which is indicated by the selection result information, through the automated vehicle 90, and then ends the third specific processing.

As described above, in the data processing system 10 according to the present embodiment, the input unit 292 acquires, as user data, image data indicating an image of an area including a sales area for products in a sales store for the products, the processing unit 294 performs, as specific processing, processing of generating sales status information based on the user data, the status information indicating a sales status for the products in the sales store, by inputting, into a data generation model, a prompt for instructing the generation of the sales status information, and the output unit 296 outputs the sales status indicated by the sales status information to a device of a producer who produces the products. Therefore, the producer can determine whether or not the products produced by the producer need to be delivered to the sales store, the timing of the delivery when the products are delivered, and the like with reference to the sales status for the products in the sales store, and as a result making it possible to more efficiently distribute the products as compared with the conventional technology.

In addition, in the data processing system 10 according to the present embodiment, agricultural products are applied as the products, and a direct sales store is applied as the sales store. Therefore, it is possible to improve the efficiency of distribution of the agricultural products through the direct sales store.

In addition, in the data processing system 10 according to the present embodiment, the input unit 292 acquires image data from direct sales stores provided at a plurality of points, the processing unit 294 performs, as specific processing, processing of generating sales status information in the direct sales stores at the plurality of points, and the output unit 296 outputs the sales status indicated by the sales status information to the device of the producer who produces the agricultural products for each of the direct sales stores at the plurality of points. Therefore, the producer can determine whether or not the products produced by the producer need to be delivered to the direct sales stores at the plurality of points, the timing of the delivery when the products are delivered, and the like, and as a result making it possible to more efficiently distribute the agricultural products.

In addition, in the data processing system 10 according to the present embodiment, the sales status information includes at least one of information regarding excessively supplied agricultural products, information regarding insufficient agricultural products, information regarding agricultural products that are sold well, and information regarding the number of visitors to the direct sales store. Therefore, the producer can refer to the information included in the sales status information, as a result making it possible to more efficiently distribute the agricultural products.

In addition, in the data processing system 10 according to the present embodiment, the input unit 292 further acquires reservation data from the producer as the user data, the reservation data indicating that a reservation is made to deliver the agricultural products produced by the producer to the direct sales store, and the processing unit 294 further performs, as the specific processing, processing of arranging a delivery vehicle for delivering the agricultural products from the producer to the direct sales store according to the reservation indicated by the reservation data. Therefore, it is possible to reduce the time and effort required for the producer to arrange the delivery of the agricultural products from the producer to the direct sales store, as a result making it possible to more efficiently distribute the agricultural products.

In addition, in the data processing system 10 according to the present embodiment, an automated vehicle that automatically moves in a set section is applied as the delivery vehicle, and the processing unit 294 further performs, as the specific processing, processing of setting a section between the producer and the corresponding direct sales store as the section. Therefore, the agricultural products can be delivered by the unmanned delivery vehicle, as a result making it possible to more efficiently distribute the agricultural products.

In addition, in the data processing system 10 according to the present embodiment, the sales status information includes information indicating an estimated future shipment amount for each type of agricultural product in the direct sales store. Therefore, the producer can refer to the estimated shipment amount for the agricultural products, as a result making it possible to more efficiently distribute the agricultural products.

Furthermore, in the data processing system 10 according to the present embodiment, the processing unit 294 further performs, as the specific processing, processing of arranging delivery of unsold agricultural products after the end of sale for the agricultural products in the direct sales store to a predetermined seller using the image data. Therefore, even unsold agricultural products may be sold, making it possible to more efficiently distribute the agricultural products.

Although the system according to the present disclosure has been described above mainly in terms of the functions of the data processing device 12, the system according to the present disclosure is not necessarily implemented on a server. The system according to the present disclosure may be implemented as a general information processing system. The present disclosure may be implemented as, for example, a software program operating on a personal computer or an application operating on a smartphone or the like. The method according to the present disclosure may be provided to a user in a software as a service (SaaS) format.

In the above-described embodiment, the specific processing is performed by one computer 22, but the technology of the present disclosure is not limited thereto, and the specific processing may be performed by a plurality of computers including the computer 22 in a distributed manner. For example, the data generation model 58 may be provided in a device external to the data processing device 12, and the external device may generate data according to input data.

In the above-described embodiment, the specific processing program 56 is stored in the storage 32, but the technology of the present disclosure is not limited thereto. For example, the specific processing program 56 may be stored in a portable computer-readable non-transitory storage medium such as a universal serial bus (USB) memory. The specific processing program 56 stored in the non-transitory storage medium is installed in the computer 22 of the data processing device 12. The processor 28 executes specific processing according to the specific processing program 56.

In addition, the specific processing program 56 may be stored in a storage device such as a server connected to the data processing device 12 via the network 54, and the specific processing program 56 may be downloaded and installed in the computer 22 in response to a request from the data processing device 12.

Note that it is not necessary to store all of the specific processing program 56 in a storage device such as a server connected to the data processing device 12 via the network 54 or to store all of the specific processing program 56 in the storage 32, and a part of the specific processing program 56 may be stored.

The following various processors can be used as hardware resources that execute the specific processing. Examples of the processors include a CPU, which is a general-purpose processor functioning as a hardware resource that executes the specific processing by executing software, that is, a program. In addition, examples of the processors include a dedicated electric circuit, which is a processor having a circuit configuration exclusively designed for executing the specific processing, such as a field-programmable gate array (FPGA), a programmable logic device (PLD), or an application specific integrated circuit (ASIC). A memory is built in or connected to any processor, and any processor executes specific processing by using the memory.

The hardware resource that executes the specific processing may be configured by one of these various processors, or may be configured by a combination of two or more processors of the same type or different types (e.g., a combination of a plurality of FPGAs or a combination of a CPU and an FPGA). The hardware resource that executes the specific processing may be one processor.

As an example in which the hardware resource that executes the specific processing is configured by one processor, first, there is a mode in which one processor is configured by a combination of one or more CPUs and software, and this processor functions as a hardware resource that executes specific processing. Second, as represented by a system-on-a-chip (SoC) or the like, there is a mode in which a processor that realizes the functions of the entire system including a plurality of hardware resources that execute the specific processing on one IC chip is used. In this manner, the specific processing is realized by using one or more of the above-described various processors as hardware resources.

Furthermore, more specifically, an electric circuit in which circuit elements such as semiconductor elements are combined can be used as a hardware structure for these various processors. In addition, the above-described specific processing is merely an example. Therefore, it is needless to say that unnecessary steps may be deleted, new steps may be added, or the processing order may be changed without departing from the gist.

The above-described and illustrated contents are detailed descriptions of parts according to the technology of the present disclosure, and are merely examples of the technology of the present disclosure. For example, the above descriptions regarding configurations, functions, operations, and effects are descriptions regarding examples of configurations, functions, operations, and effects of parts according to the technology of the present disclosure. Therefore, it is needless to say that unnecessary parts may be deleted, new parts may be added, or some parts may be replaced with respect to the above-described and illustrated contents without departing from the gist of the technology of the present disclosure. Furthermore, in order to avoid complication and to facilitate understanding of parts according to the technology of the present disclosure, in the above-described and illustrated contents, descriptions regarding common technical knowledge and the like that do not require any particular description to enable the implementation of the technology of the present disclosure are omitted.

All the documents, patent applications, and technical standards described in the present specification are incorporated herein by reference to the same extent as if each document, patent application, and technical standard were specifically and individually indicated to be incorporated by reference.

In the above-described embodiment, the data processing device of the present disclosure is applied to the data processing device 12 configured as a server, but the application of the data processing device of the present disclosure is not limited to this mode. For example, the data processing device of the present disclosure may be applied to the smart device 14.

In the above-described embodiment, the sales status screen is displayed on the smart device 14 possessed by the producer, but the display of the sales status screen is not limited to this mode. For example, the sales status screen may be displayed on an information processing device other than the smart device 14 used by the producer.

In addition, although not mentioned in the above-described embodiment, the direct sales store displayed first on the sales status screen may be narrowed down to only direct sales stores where the agricultural products can be delivered from the producer from which access has been made. In addition, the types of agricultural products to be displayed on the sales status screen may be narrowed down only to the type of agricultural product produced by the producer from which access has been made.

With regard to the above, the following supplementary notes are further disclosed.

### Supplementary Note 1

A data processing device including:
an input unit configured to acquire user data;
a processing unit configured to perform specific processing using a data generation model that generates a predetermined inference result according to the user data; and
an output unit configured to output a result of the specific processing to a predetermined device,
in which the input unit acquires, as the user data, image data indicating an image of an area including a sales area for products in a sales store for the product,
the processing unit performs, as the specific processing, processing of generating sales status information based on the user data, the sales status information indicating a sales status for the products in the sales store, by inputting, into the data generation model, a prompt for instructing the generation of the sales status information, and
the output unit outputs the sales status indicated by the sales status information to a device of a producer who produces the products.

### Supplementary Note 2

The data processing device according to supplementary note 1, in which
the products are agricultural products, and
the sales store is a direct sales store.

### Supplementary Note 3

The data processing device according to supplementary note 2, in which
the input unit acquires image data from direct sales stores provided at a plurality of points,
the processing unit performs, as the specific processing, processing of generating sales status information in the direct sales stores at the plurality of points, and
the output unit outputs the sales status indicated by the sales status information to the device of the producer who produces the agricultural products for each of the direct sales stores at the plurality of points.

### Supplementary Note 4

The data processing device according to supplementary note 2 or 3, in which
the sales status information includes at least one of information regarding excessively supplied agricultural products, information regarding insufficient agricultural products, information regarding agricultural products that are sold well, and information regarding the number of visitors to the direct sales store.

### Supplementary Note 5

The data processing device according to any one of supplementary notes 2 to 4, in which
the input unit further acquires reservation data from the producer as the user data, the reservation data indicating that a reservation is made to deliver the agricultural products produced by the producer to the direct sales store, and
the processing unit further performs, as the specific processing, processing of arranging a delivery vehicle for delivering the agricultural products from the producer to the direct sales store according to the reservation indicated by the reservation data.

### Supplementary Note 6

The data processing device according to supplementary note 5, in which
the delivery vehicle is an automated vehicle that automatically moves in a set section, and
the processing unit further performs, as the specific processing, processing of setting a section between the producer and the corresponding direct sales store as the section.

### Supplementary Note 7

The data processing device according to any one of supplementary notes 2 to 6, in which
the sales status information includes information indicating an estimated future shipment amount for each type of agricultural product in the direct sales store.

### Supplementary Note 8

The data processing device according to any one of supplementary notes 2 to 7, in which
the processing unit further performs, as the specific processing, processing of arranging delivery of unsold agricultural products after an end of sale for the agricultural products in the direct sales store to a predetermined seller using the image data.

### Supplementary Note 9

A data processing method executed by a computer, the data processing method including:
acquiring user data;
performing specific processing using a data generation model that generates a predetermined inference result according to the user data; and
outputting a result of the specific processing to a predetermined device,
in which image data is acquired as the user data, the image data indicating an image of an area including a sales area for products in a sales store for the product,
processing of generating sales status information based on the user data is performed as the specific processing, the sales status information indicating a sales status for the products in the sales store, by inputting, into the data generation model, a prompt for instructing the generation of the sales status information, and
the sales status indicated by the sales status information is output to a device of a producer who produces the products.

### Supplementary Note 10

A data processing program for causing a computer to execute:
acquiring user data;
performing specific processing using a data generation model that generates a predetermined inference result according to the user data; and
outputting a result of the specific processing to a predetermined device,
in which image data is acquired as the user data, the image data indicating an image of an area including a sales area for products in a sales store for the product,
processing of generating sales status information based on the user data is performed as the specific processing, the sales status information indicating a sales status for the products in the sales store, by inputting, into the data generation model, a prompt for instructing the generation of the sales status information, and
the sales status indicated by the sales status information is output to a device of a producer who produces the products.

What is claimed is:

1. A data processing device comprising:
a processor,
wherein the processor is configured to:
acquire, as user data, image data indicating an image of an area including a sales area for products in a sales store for the product;
perform, as specific processing, processing of generating sales status information based on the user data, the sales status information indicating a sales status for the products in the sales store, by inputting, into a data generation model that generates a predetermined inference result according to the user data, a prompt for instructing the generation of the sales status information; and
output the sales status indicated by the sales status information as a result of the specific processing to a device of a producer who produces the products.

2. The data processing device according to claim 1, wherein
the products are agricultural products, and
the sales store is a direct sales store.

3. The data processing device according to claim 2, wherein
the processor is configured to:
acquire image data from direct sales stores provided at a plurality of points;
perform, as the specific processing, processing of generating sales status information in the direct sales stores at the plurality of points; and
output the sales status indicated by the sales status information to the device of the producer who produces the agricultural products for each of the direct sales stores at the plurality of points.

4. The data processing device according to claim 2, wherein
the sales status information includes at least one of information regarding excessively supplied agricultural products, information regarding insufficient agricultural products, information regarding agricultural products that are sold well, and information regarding the number of visitors to the direct sales store.

5. The data processing device according to claim 2, wherein
the processor is configured to:
further acquire reservation data from the producer as the user data, the reservation data indicating that a reservation is made to deliver the agricultural products produced by the producer to the direct sales store; and
further perform, as the specific processing, processing of arranging a delivery vehicle for delivering the agricultural products from the producer to the direct sales store according to the reservation indicated by the reservation data.

6. The data processing device according to claim 5, wherein
the delivery vehicle is an automated vehicle that automatically moves in a set section, and
the processor is configured to further perform, as the specific processing, processing of setting a section between the producer and the corresponding direct sales store as the section.

7. The data processing device according to claim 2, wherein
the sales status information includes information indicating an estimated future shipment amount for each type of agricultural product in the direct sales store.

8. The data processing device according to claim 2, wherein
the processor is configured to further perform, as the specific processing, processing of arranging delivery of unsold agricultural products after an end of sale for the agricultural products in the direct sales store to a predetermined seller using the image data.

9. A data processing method executed by a computer, the data processing method comprising:
acquiring, as user data, image data indicating an image of an area including a sales area for products in a sales store for the product;
performing, as specific processing, processing of generating sales status information based on the user data, the sales status information indicating a sales status for the products in the sales store, by inputting, into a data generation model that generates a predetermined inference result according to the user data, a prompt for instructing the generation of the sales status information; and
outputting the sales status indicated by the sales status information as a result of the specific processing to a device of a producer who produces the products.

10. A non-transitory recording medium recording a data processing program for causing a computer to execute:
acquiring, as user data, image data indicating an image of an area including a sales area for products in a sales store for the product;
performing, as specific processing, processing of generating sales status information based on the user data, the sales status information indicating a sales status for the products in the sales store, by inputting, into a data generation model that generates a predetermined inference result according to the user data, a prompt for instructing the generation of the sales status information; and
outputting the sales status indicated by the sales status information as a result of the specific processing to a device of a producer who produces the products.
